(19) United States
(12) Patent Application Publication
(10) Pub. No.: US 2002/0190920 A1
(43) Pub. Date: Dec. 19, 2002

(54) Personal digital assistant with a power-saving external image output port

(76) Inventor: Shao-Tsu Kung, Taipei (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,133

(22) Filed: Nov. 25, 2001

(30) Foreign Application Priority Data
Jun. 15, 2001 (TW) 090114513

(51) Int. Cl. G09G 5/00

(52) U.S. Cl. 345/3.1

(57) ABSTRACT

The PDA includes a memory for storing programs and data including an image frame data set, a memory controller connected to the memory, an LCD (liquid crystal display) panel for displaying a video image, and a first display controller for converting the image frame data set stored in the memory into a first image signal and passing it to the LCD panel to display the image contained in the image frame data set. The PDA further includes a second display controller for converting the image frame data set stored in the memory into a second image signal and passing it to the image output port so that an external image display device connected to the image output port can display the image, and a central processing unit for executing programs and controlling the operations of the PDA.

### BACKGROUND OF THE INVENTION

1. Field of the Invention

The present invention relates to a personal digital assistant (PDA), and more particularly to a PDA with a power-saving external display interface.

2. Description of the Prior Art

Modern society is full of a wide range of information, and requires efficiency for everything. Consequently, the personal digital assistant (PDA) has become a necessity for businessmen and people who need more organization in their lives. For the purpose of saving power and extending operating time, PDAs are generally manufactured without some common devices used in laptop computers. As a result, it is sometimes inconvenient for consumers to use such PDAs. For example, an external image output port is implemented on a general notebook to allow the connection of external display devices such as a projector or a monitor. For image signals with high resolutions (as least 640×480), output from the external image output port is generated by a high-resolution display controller of the notebook such as a VGA display controller. The high-resolution display controller consumes a great deal of power, and as a result is not suitable for implementation on a PDA, which only needs a low-resolution display controller. Therefore, the general PDA does not contain such a high-resolution image display port. When showing image data stored on the PDA via a general projector or monitor, the user must first upload the image data stored on the PDA to an external computer because of the lack of the high-resolution display controller. Then, the high-resolution display controller of the external computer outputs the image data to the external projector or computer. This uploading process causes extrainconvenience for PDA users.

### SUMMARY OF THE INVENTION

The main objective of the claimed invention is to solve the problem mentioned above by providing a PDA containing a power-saving and high-resolution image output port.

The PDA comprises a memory for storing programs and data (including an image frame data set), a memory controller connected to the memory for controlling data access of the memory, an LCD (liquid crystal display) panel for displaying a video image, and a first display controller connected between the LCD panel and the memory controller for converting the image frame data set stored in the memory into a first image signal and passing it to the LCD panel for displaying the image. The PDA further comprises a second display controller connected between the memory controller and an image output port for converting the image frame data set stored in the memory into a second image signal and passing it to the image output port. An external image display device can be connected to the image output port to display the image contained in the image frame data set. In addition, the PDA also comprises a central processing unit connected to the memory controller for executing programs stored in the memory to control the operations of the PDA. The images produced by the first display controller and the second display controller are not identical. Although they both are generated from the same image frame data set stored in the memory, the horizontal and vertical resolutions of the first and second image signals are different.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a diagram of a PDA according to the present invention.

FIG. 2 is an internal function block diagram of the PDA shown in FIG. 1.

### DETAILED DESCRIPTION

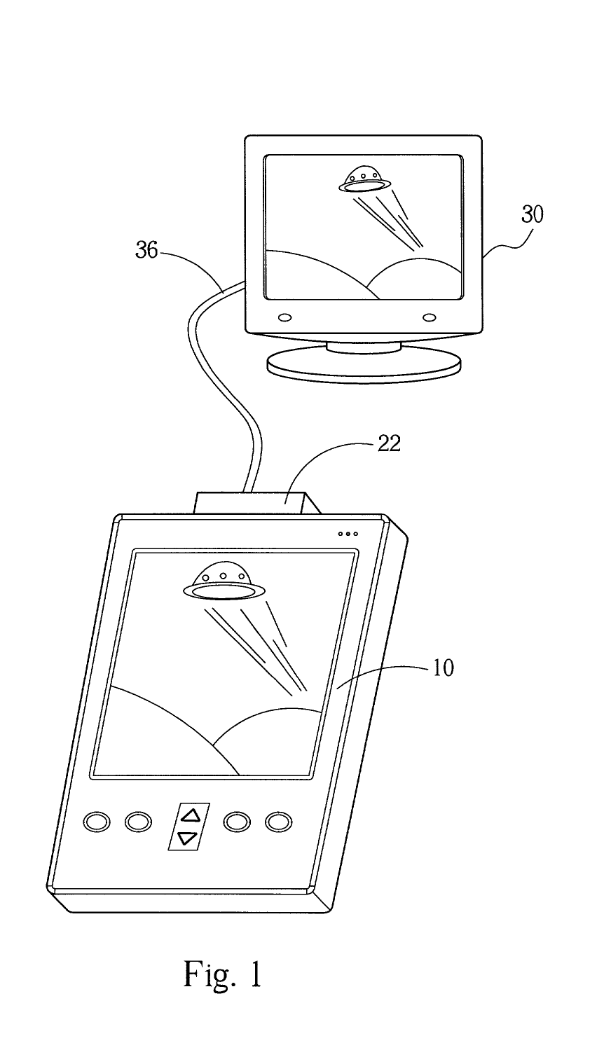

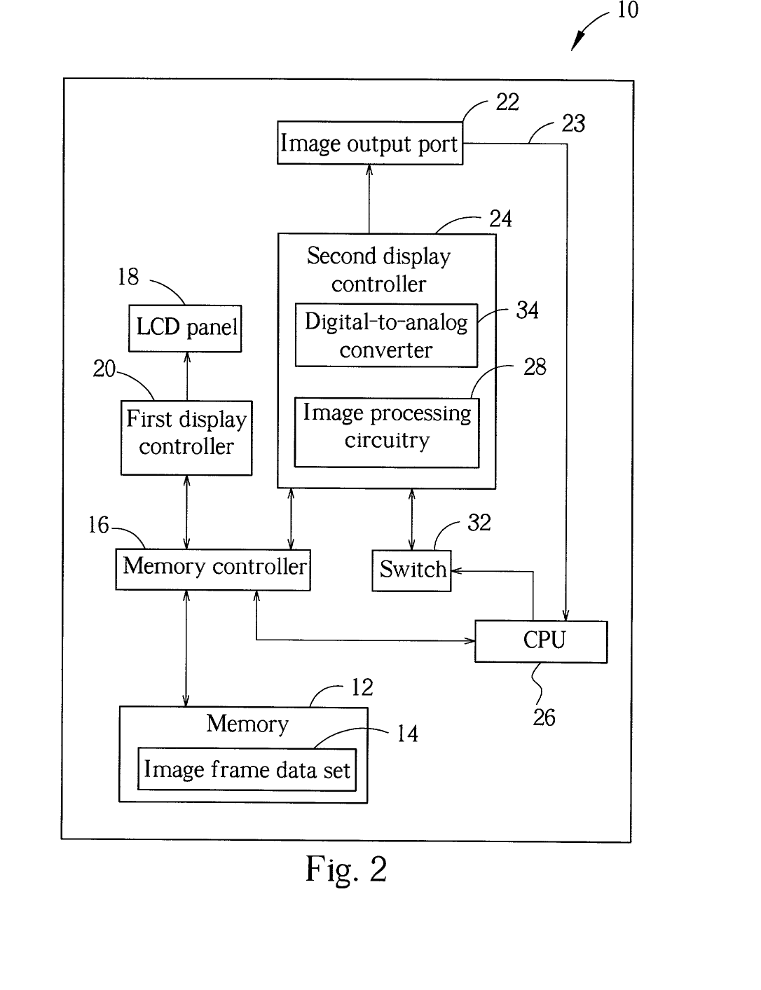

Please refer to FIG. 1 and FIG. 2. FIG. 1 is a diagram of a PDA 10 according to the present invention. FIG. 2 is an internal function block diagram of the PDA 10 shown in FIG. 1. The PDA 10 comprises an image output port 22, a LCD (liquid crystal display) panel 18, a first display controller 20, a memory controller 16, a memory 12, a second display controller 24, and a central processing unit (CPU) 26. The memory 12 is used to store programs and data, and includes at least an image frame data set 14. The memory controller 16, electronically connected to the memory 12, controls data access of the memory 12. The LCD panel 18 is a LCD-based touch screen panel used to display an image and accept instructions entered by input devices such as touch pens or fingers. The resolution of the LCD panel 18 is generally 320×240, which is lower than a normal computer monitor. In most cases, the normal computer monitor's resolution is 640×480 or higher. The first display controller 20, electronically connected between the LCD panel 18 and the memory controller 16, converts the image frame data set 14 stored in the memory 12 into a first image signal to the LCD panel 18. The first display controller 20 is used to control the LCD panel 18, and is capable of displaying the image contained in the image frame data set 14. The image output port 22 is used to output image signals. The second display controller 24 is the display controller of the image display device 30. The second display controller 24, which is electronically connected between the memory controller 16 and an image output port 22, converts the image frame data set 14 contained in the memory 12 into a second image signal to the image output port 22 so that the external image display device 30 connected to the image output port 22 is capable of displaying the image contained in the image frame data set 14. The image display device 30 can be a cathode ray tube (CRT) or a liquid crystal display (LCD) with higher display resolution than the LCD panel 18.

The horizontal and vertical resolutions of the first and second image signals are different although they both are generated from the same image frame data set 14. The central processing unit (CPU) 26, electronically connected to the memory controller 16, executes programs stored in the memory 12 to control the operations of the PDA 10. The second display controller 24 is not an ordinary high-resolution display controller such as a VGA controller for power consumption concerns. As shown in FIG. 2, the second display controller 24 comprises an image processing circuitry 28 and a digital-to-analog converter 34. The image processing circuitry 28 is used to increase horizontal and vertical resolutions of the image contained in the image frame data set 14 and to fix the sawtooth pattern generated by increasing the resolutions. The digital-to-analog converter 34 is used to convert the digital signals generated from the image processing circuitry 28 into analog signals for use in the image display device 30.

In addition, the PDA 10 further comprises a switch 32 electronically connected to the CPU 26 to turn the second display controller 24 on and off. A detecting wire 23 is connected between the CPU 26 and one pin of the image output port 22. When the image output port 22 is disconnected from the image display device 30, the CPU 26 turns off the second display controller 24 through the switch 32 for the purpose of saving power. When the image display device 30 is electronically connected to the image output port 22 by a wire 36, the CPU 26 detects such a connection through the detecting wire 23. The CPU 26 then turns on the second display controller 24 by means of the switch 32 to pass the second image signal generated from the second display controller 24 to the image display device 30.

In contrast with known PDAs, the PDA 10 according to the present invention not only directly transfers images contained in the PDA 10 to an external image display device 30 via the image output port 22 but also does not consume much power with the second display controller 24 implemented. Therefore, the present invention makes using PDAs considerably more convenient.

The above disclosure is not intended as limiting. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A personal digital assistant (PDA) comprising:
a memory for storing programs and data having an image frame data set;
a memory control electrically connected to the memory for controlling data access of the memory;
an LCD (liquid crystal display) panel for displaying a video image;
a first display control electrically connected between the LCD panel and the memory control for converting the image frame data set stored in the memory into a first image signal and passing the first image signal to the LCD panel so that the LCD panel is capable of displaying the image contained in the image frame data set;
a second display control electrically connected between the memory control and an image output port for converting image frame data set stored in the memory into a second image signal and passing the second image signal to the image output port so that an external image display device connected to the image output port is capable of displaying the image contained in the image frame data set, the first image signal and the second image signal having different horizontal and vertical resolutions; and
a central processing unit electrically connected to the memory control for executing programs stored in the memory to control operations of the PDA.

2. The PDA of claim 1 wherein the second display control comprises image process circuitry for increasing horizontal and vertical resolutions of the image contained in the image frame data set and fixing sawtooth generated by increasing the resolutions.

3. The PDA of claim 1 wherein the image display device connected to the image output port is a cathode ray tube (CRT) display or a liquid crystal display (LCD).

4. The PDA of claim 1 further comprising a switch for turning on and off the second display control.

5. The PDA of claim 4 wherein the switch turns on and off the second display control according to a connection status of the image display device and the image output port.

6. The PDA of claim 1 wherein the LCD panel is a touch screen.
